(19) United States
(12) Patent Application Publication
(10) Pub. No.: US 2015/0324862 A1
(43) Pub. Date: Nov. 12, 2015

(54) METHODS AND APPARATUS FOR INITIATING COMMUNICATION BETWEEN PARTIES

(71) Applicant: Nice Frog Inc., Greenwich, CT (US)

(72) Inventors: Robert Burchetta, Greenwich, CT (US); James D. Burchetta, Greenwich, CT (US)

(21) Appl. No.: 14/707,364

(22) Filed: May 8, 2015

Related U.S. Application Data
(60) Provisional application No. 61/991,610, filed on May 11, 2014.

(51) Int. Cl. G06Q 30/02

(52) U.S. Cl. CPC G06Q 30/0269

(57) ABSTRACT

The present disclosure relates to methods and apparatus for safely and securely initiating communication between parties. More particularly, the present disclosure relates to utilizing a logo as an indication of availability and as a means for a second party to show interest without requiring an exchange of personal information.

### CROSS-REFERENCE TO RELATED APPLICATION

This application claims priority to and the full benefit of U.S. Provisional Patent Application Ser. No. 61/991,610, filed May 11, 2014, and titled “METHODS AND APPARATUS FOR INITIATING COMMUNICATION BETWEEN PARTIES”, the entire contents of which are incorporated herein by reference.

### FIELD OF DISCLOSURE

This disclosure relates to methods and apparatus for safely and securely initiating communication between parties. More particularly, the present disclosure relates to utilizing a logo as an indication of availability and as a means for a second party to show interest without requiring an exchange of personal information.

### BACKGROUND

Traditionally, when a party wanted to place a good on the market, such as a car or a property, the party placed an ad in a newspaper or posted signs on or near the product. The ad or signs would likely contain some personal contact information, which would allow an Interested Party to contact the seller. The parties would then arrange to meet and discuss the terms of the sales, and if the terms were agreeable to both parties, they may conduct a transaction.

More recently, websites embody a virtual “Want Ad” formerly seen in printed publications. For example, websites such as Craigslist or eBay allow sellers to reach a broader audience and, in some cases, provide a secure payment platform. However, the transactions still typically involve some exchange of personal information and/or a risky meeting arrangement.

In addition, according to traditional methods of marketing and exchange, a car or other property needed to be actively listed and offered sale. A potential customer would need to access a DMV or property records in order to ascertain an owner of a care or property not listed for sale.

What is needed therefore is a convenient, safe, and effective way to convey availability of a product and a responsive interest in the product.

### SUMMARY

Accordingly, the present disclosure provides methods and device to utilizing a logo as an indication of availability and as a means for a second party to show interest without requiring an exchange of personal information, and therefore, overcomes the disadvantages of prior art as briefly described above.

A system of one or more computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computing apparatus capable of facilitating communication between an advertiser and an Interested Party, where the computing apparatus includes: a communications network access device for accessing a server in logical communication with a communications network; and executable software stored on the communications network access device and executable on demand.

The computing also enables the receipt of identification information associated with an available product, service or person, where an owner is associated with the available product, service or person. The computing also includes transmitting the identification information to an external server. The computing also includes receiving profile information from the external server, where the profile information is associated with the transmitted identification information. The computing also includes presenting the profile information to a prospective party. The computing also includes prompting the prospective party to respond to the presented profile information. The computing also includes receiving the response from the prospective party, where the response is indicative of interest or lack of interest in the available product, service or person. Other examples of this aspect include corresponding computer systems, apparatus, and computer programs recorded on one or more computer storage devices, each configured to perform the actions of the methods.

Implementations may include one or more of the following features. Implementations may include the apparatus where the identification information is logically embedded in a logo configured to be placed on or proximate to the available product, service or person. Implementations may include the apparatus where the logo further includes a tag configured to wirelessly transmit the identification information to the network access device. Implementations may include the computing apparatus where the communications network access device is further caused to transmit energy to the tag. Implementations may include the computing apparatus where the identification information is logically embedded in a readable code portion of the logo. Implementations may include the computing apparatus where the communications network access device is further caused to notify the prospective party of a receipt of the identification information. Implementations may include the computing apparatus where the response indicates interest in the available product, service or person, and where a prospective party becomes an Interested Party, and where the communications network access device is further caused to initiate communication between the Interested Party and the owner. Implementations may include the computing apparatus where the communication between the Interested Party and the owner further causes the communications network access device to: transmit the response to the owner; receive a first communication from the owner; present the first communication to the Interested Party; receive a second communication from the Interested Party; and transmit the second communication to the owner. Implementations may include the computing apparatus where the first or the second communication includes a transaction offer for the available product, service or person between the owner and the Interested Party. Implementations may include the computing apparatus where the first or the second communication includes an acceptance of the transaction offer for the available product, service or person. Implementations may include the computing apparatus where the communications network access device is further caused to commence a commercial transaction based on the transaction offer.

Methods may additionally include the steps of: presenting a data stream to an operator of a computing device, where the presenting of the data stream identifies to the operator of the computing device an interest prompt and a contact information data segment; and collecting a user response from the operator of the computing device; transmitting a data stream to another computing device, where the application software operating on the other computing device may process the data stream; and communicating to an operator of the other computing device a response, where the response is based upon the information in the data stream.

The method may include examples where an identification device includes an image. An example may include the method where the image includes a logo associated with a first entity, where the first entity provided the application software operating on a first computing device. Additional examples may include the method where the image includes a modified logo associated with a second entity, where the second entity is associated with the first user. Additional examples may include the method where the identification device includes a wireless communication device. Additional examples may include the method wherein the wireless communication device includes an Radio Frequency Identification (RFID) and the method wherein the wireless communication device includes a bluetooth enabled device. Implementations of the described techniques may include hardware, a method or process, or computer software on a computer-accessible medium.

One general aspect includes a method of initiating communication between at least two parties, the method including the steps of: providing an identification device to a first user, where the identification device contains a unique identifier; providing application software to a second user, where the application software may be operated on a first computing device, where the first computing device may also interact with the identification device to extract the unique identifier; receiving on a second computing device a communication originating from the first computing device, where the communication signals an interest prompt from the application software operating on the first computing device; extracting the unique identifier from the communication; accessing a database, where the database contains profile information, where at least a portion of the profile information may be associated with the unique identifier; retrieving a contact information data segment associated with the unique identifier from the database; and transmitting a data stream to a third computing device, where the data stream contains the interest prompt and the contact information data segment, where the third computing device is associated with the first user. Other examples of this aspect include corresponding computer systems, apparatus, and computer programs recorded on one or more computer storage devices, each configured to perform the actions of the methods.

Implementations may include one or more of the following features. Implementations may include the method additionally including the steps of: presenting the data stream to an operator of the third computing device, where the presenting of the data stream identifies to the operator of the third computing device the interest prompt and the contact information data segment; and collecting a user response from the operator of the third computing device; transmitting a data stream to the first computing device, where the application software operating on the first computing device may process the data stream; and communicating to an operator of the first computing device a response, where the response is based upon the information in the data stream. Implementations may include the method where the identification device includes an image. Implementations may include the method where the image includes a logo associated with a first entity, where the first entity provided the application software operating on the first computing device. Implementations may include the method where the image includes a modified logo associated with a second entity, where the second entity is associated with the first user. Implementations may include the method where the identification device includes a wireless communication device. Implementations may include the method where the wireless communication device includes an rfid. Implementations may include the method where the wireless communication device includes a bluetooth enabled device. Implementations of the described techniques may include hardware, a method or process, or computer software on a computer-accessible medium.

The details of one or more examples of the disclosure are set forth in the accompanying drawings and the description below. The accompanying drawings that are incorporated in and constitute a part of this specification, illustrate several examples of the disclosure and, together with the description, serve to explain the principles of the disclosure: Other features, objects, and advantages of the disclosure will be apparent from the description, drawings and the claims herein.

### DESCRIPTION OF THE DRAWINGS

The foregoing and other features and advantages of the disclosure will be apparent from the following, more particular description of preferred examples of the disclosure, as illustrated in the accompanying drawings.

FIG. 1A illustrates an exemplary embodiment of a logo affixed to a building, wherein the logo may be indicative of property availability.

FIG. 1B illustrates an exemplary embodiment of a logo affixed to a shop, wherein the logo may be indicative of product availability within the shop.

FIG. 1C illustrates an exemplary embodiment a logo affixed to a bumper of a vehicle, wherein the logo may indicate that the car may be for sale.

FIG. 1D illustrates an exemplary embodiment including wearable tags, wherein the tag may be indicative of availability.

FIG. 2A illustrates an exemplary embodiment of a logo.

FIG. 2B illustrates an alternate exemplary embodiment of a logo.

FIG. 3 illustrates an exemplary system for accessing product information of an available product.

FIG. 4 illustrates an exemplary system for receiving identification information of an available product.

FIG. 5 illustrates an exemplary system for accessing product information of multiple available products.

FIG. 6 illustrates an exemplary processing and interface system.

FIG. 7 illustrates exemplary method steps for wirelessly receiving profile information, wherein the identification information may be received through a wireless transmission from a tag on a logo.

FIG. 8 illustrates exemplary method steps for wirelessly receiving profile information, wherein the identification information may be retrieved through capture of a code or image of a logo.

FIG. 9 illustrates exemplary method steps for initiating direct communication between a profile owner and an Interested Party.

FIG. 10 illustrates exemplary method steps for transmitting profile information to an external device.

FIG. 11 illustrates exemplary method steps for allowing direct communication between a profile owner and an Interested Party.

### DETAILED DESCRIPTION

The present disclosure relates generally apparatus and systems for facilitating communications between parties in controlled manners. Generally, a user operates network access device, such a smart phone is used to transmit a unique identifier affixed to an item. The smart phone will then receive back information relating to the item and may also be used to communicate to a person associated with the item. Some examples may include the person associated with the item communicating directly to the user.

### Glossary

As used herein the following terms will have the following associated meaning:

Available: as used herein describes a person or product that may be on the market. For example, an available product may be on the market for sale, rent, lease, or other means of conveyance. Similarly, an available person may be on the market for socializing, dating, or hiring, for example.

Tag: as used herein refers to a detectable marker that may be embedded in a logo or may be attached separately to an available good or person. In some examples, a tag may comprise embedded information detectable though RFID, Bluetooth, or Wi-Fi, as non-limiting examples.

Logo: as used herein refers to an image that indicates availability of a good or person, and wherein the image further comprises a unique identification code, such as a QR or bar code.

Interested Party: as used herein refers to an individual, company, or group that may be in interested in a particular product, service or person that they have seen or have accessed data associated with that product, service or person.

Prospective Party: as used herein refers to individuals, companies, or groups that may potentially be interested in a particular product, service or person if and when the prospective party is made aware of the particular product, service or person.

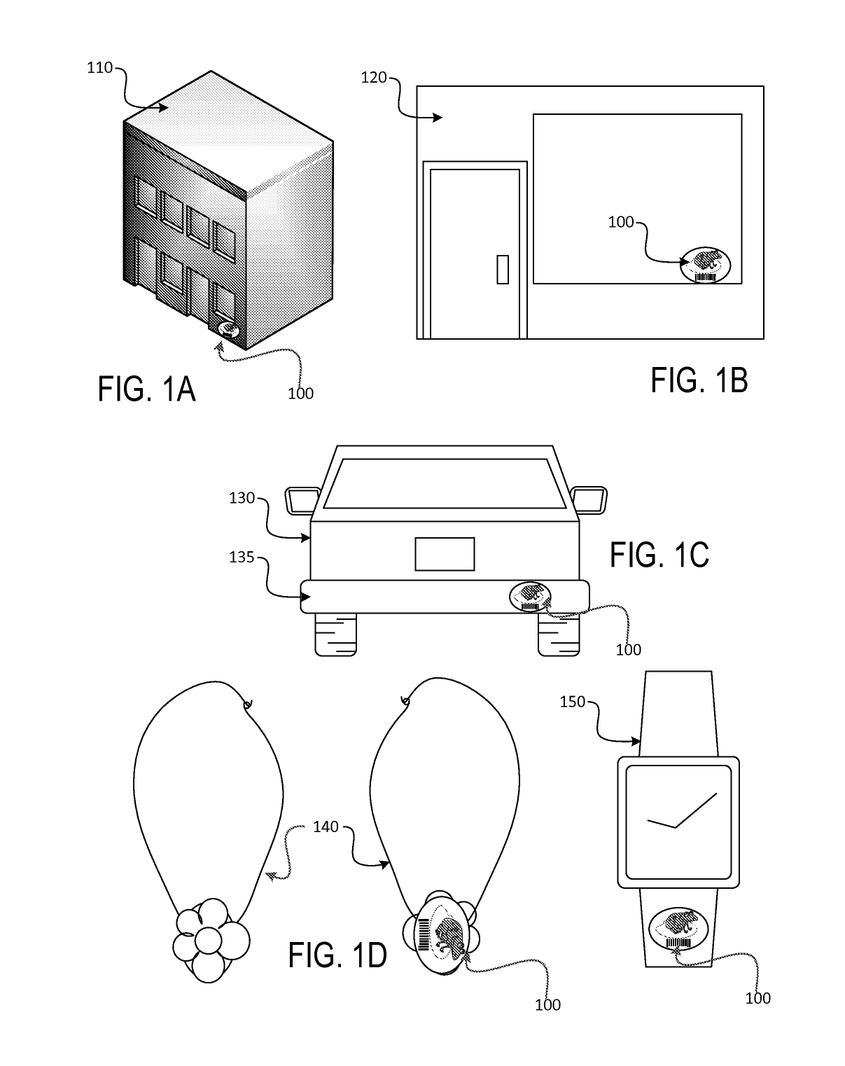

Referring now to FIG. 1A, an exemplary embodiment of a logo 100 affixed to a building 110, wherein the logo may be indicative of property availability, is illustrated. In some examples, the logo 100 may indicate that the entire building 110 is for sale or lease. In other examples, the logo 100 may indicate that a portion of the building 110 may be available for sale, rent, or lease. For example, a building 110 may comprise multiple office spaces, apartment, or parking spaces, which may be sold, rented, or leased separately. There may be other aspects of the building that may be associated with an attached logo of the type indicated at 100.

Referring now to FIG. 1B, an exemplary embodiment of a logo 100 affixed to a shop 120, wherein the logo 100 may be indicative of product availability within the shop 120, is illustrated. In some examples, the logo 100 may be placed in a location visible from the exterior of the shop 120, which may allow potential interested parties to view product availability outside of normal operating hours of the shop 120. In subsequent steps, the potential Interested Party may signal there interest in the products or services of the shop 120.

Referring now to FIG. 1C, an exemplary embodiment of a logo 100 affixed to a bumper 135 of a vehicle 130, wherein the logo 100 may indicate that the vehicle 130 may be for sale, is illustrated. In some examples, the logo 100 may be affixed to a window, which may allow for easier visibility and image capture access for potential interested parties. In some other examples, the logo 100 may represent a service that is offered by the operator of the vehicle 130. There may be numerous products, services or people that may be associated with the placement of the logo 100 on a vehicle 130.

In some examples, a car dealership may utilize removable logos on their available inventory, wherein the logos may be removed once the vehicle has been sold or leased. Data for the car may be linked to its adhered logo. In such examples, an Interested Party may scan the logo, evaluate the vehicle features, and determine what offer, if any, may be reasonable.

Examples may also include a designated location and date and time for vehicles, or other items identified by a logo to be displayed. For example, the present disclosure enables a hybrid physical/virtual swap meet to take place at a designated venue. Vehicles may be brought to a venue on a designated day and potential customers may peruse the vehicles identified via a logo. If the potential customer desires additional information, such as the year, model, specifications, miles and other associated information, the user may scan the logo and use the scan information to access related information on a website associated with the logo listing.

Referring now to FIG. 1D, examples of wearable tags, wherein the tag may be indicative of availability, are illustrated. In some examples, the tags may comprise a logo or an RFID, which may be detectable by portable mobile devices, such as, smartphones or tablets. In some examples, such tags may be paired with a social network profile or a profile specific to an event, such as a conference or symposium. For example, a wearer may pair earrings 140 or a watch 150 to a dating website, wherein the wearer may only detect and be detectable to other members of the dating site. The wearer may limit the area of detection, for example, to a distance or one meter or less from the wearer or alternatively to a larger area. The wearer may limit the functionality of the tag to a geographical region such as in these non-limiting examples, an area of town, a particular venue, or an event.

Other examples include wearing a nametag to a conference or symposium or other event. The name tag may or may not be associated with the conference sponsor. The nametag will include a link to a website including additional information about the person wearing the name tag, or other information the person wearing the name tag may wish to communicate.

By way of non-limiting example, a person at a symposium, conference or other organized event may wear a tag and another event attendee may scan the tag. The information associated with the tag may relate directly to the person wearing the tag, or to and organization or topic the person wearing the tag wishes to convey information on.

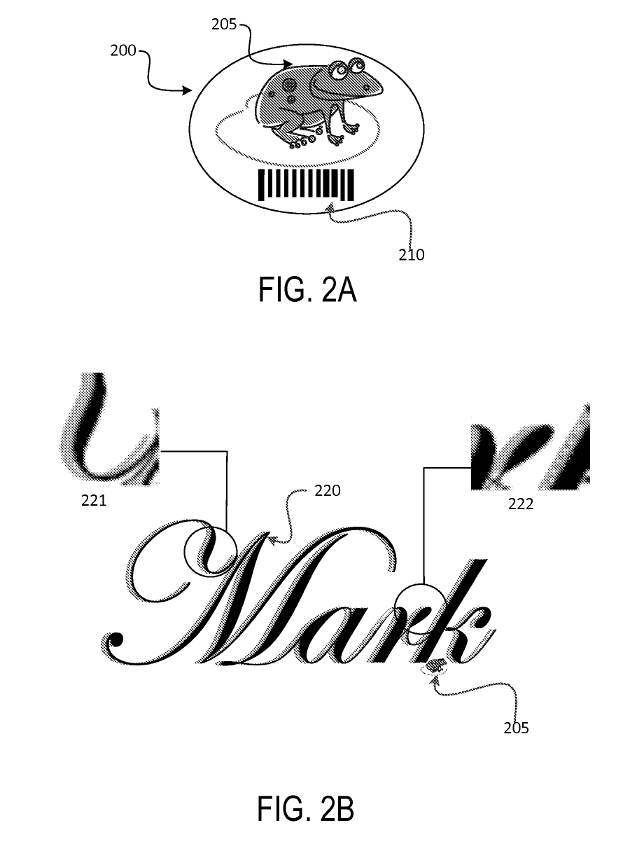

Referring now to FIGS. 2A and 2B, examples of a logo are illustrated. In some examples, as shown in FIG. 2A, the logo 200 may comprise an image 205 and a separate identification code 210, such as a bar code identification or QR code. In some examples, the logo at 200 may be associated with a particular company that offers application software, services and/or hardware associated with the types of examples that are described herein. Alternatively, such as shown in FIG. 2B, a company or user may utilize their own mark as a base image for the identification device. The user's mark may be altered in subtle ways that may embed an identification code into their mark 220, wherein the coding may not distract from the company mark 220. In some examples, a company may embed image differences that provide encoding into their logo, wherein the logo may comprise at least one coded portion 222, in contrast to a non-coded portion 221.

The image differences may be extracted through an algorithm which accesses a standard image version of the user's logo and compares the differences of the captured image with the standard logo image. The algorithm may be performed with a computing device, which may be integrated into the mobile reader device, such as a smartphone, tablet, or laptop. The presence of a small version of a provider's logo image 205 may support application software in determining whether a given logo image should contain an encoded portion that may contain a unique identifier. In some examples, the image may comprise redundant sets of coded portions 222, which may increase reader reliability.

In some examples, the image 205 may indicate that the associated person or product participates in the communication program, and the image 205 may be integrated into the company mark 220 to notify prospective parties that the mark 220 may be scanned. In some examples, the image 205 may be situated similarly to a “TM” that indicates a trademark, wherein the image 205 may be apparent but identifiable as separate from the company mark 220.

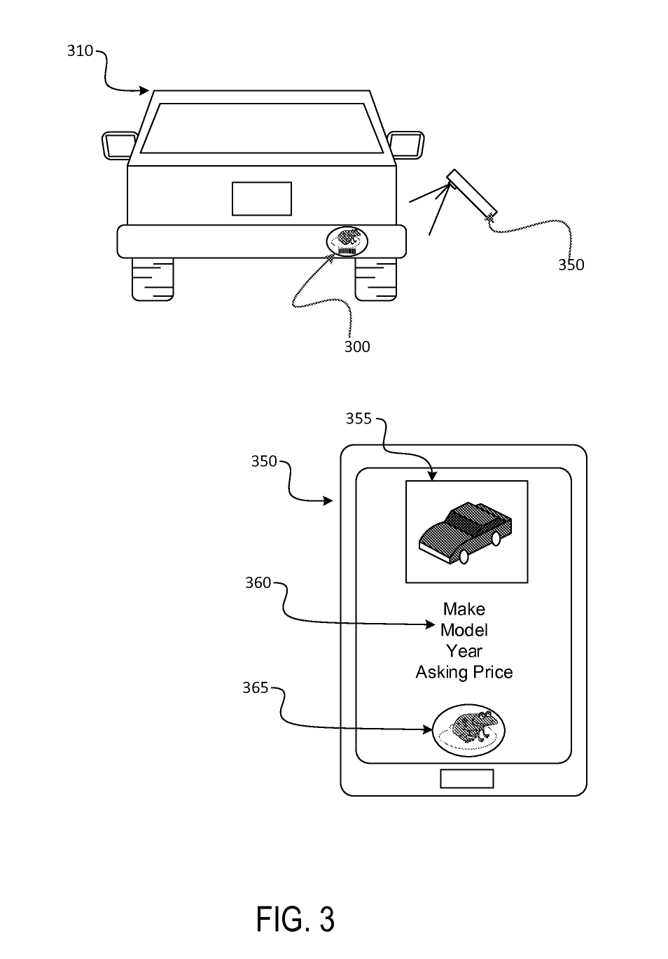

Referring now to FIG. 3, an exemplary system for accessing product information of an available product is illustrated. In some examples, a logo 300 may be affixed to the bumper of a vehicle 310, and an Interested Party may scan or capture the logo 300 utilizing a mobile device 350, such as a smartphone. In a non-limiting example, the smartphone may be used as a camera to collect a camera image of the identification device. In some examples, the mobile device 350 may be used in part of a process to retrieve information associated with the product profile and present it to the Interested Party. For example, the mobile device 350 may present a photograph 355 and specifications 360 of the vehicle 310. The mobile device 350 may allow the Interested Party to initiate an offer or to find more information, for example, by selecting a functional icon 365, which may trigger a secure communication to the seller.

The secure communication may or may not require nor include personal information from either party as implemented in a given implementation, wherein communication may occur through a secondary network. For example, the method of communication between the parties may be texting, but the texting may not occur directly between the phone numbers. In some embodiments, the provider of the identification related services described herein may provide temporary, anonymous user-ids, and the like to allow for communication through various channels including in a non-limiting sense, email, chat, text, social media or other such means.

In some examples, an Interested Party may scan a logo with a scanning device, such as a mobile phone or a tablet. The scanning device may transmit the captured logo to a server over a network, wherein the server may access a database and transmit the product information associated with the captured logo. The Interested Party may review the product information and determine if they may want to show interest. In some examples, the Interested Party may show interest by making an offer on the product, wherein the offer may comprise proposed terms, such as price or lease period.

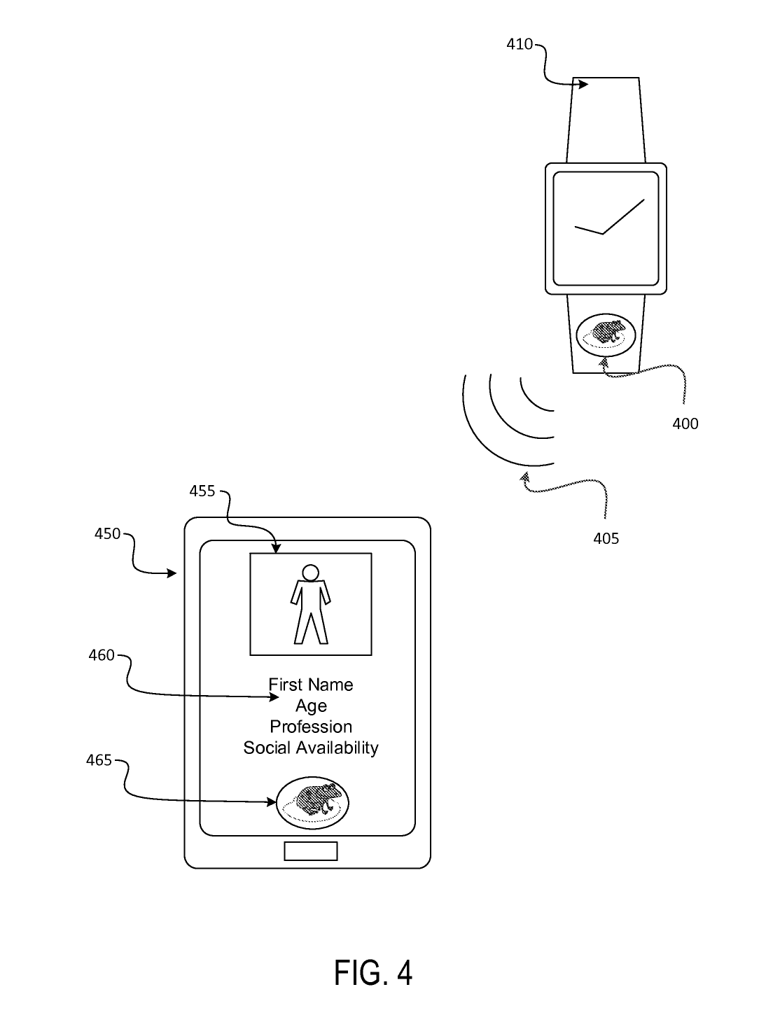

Referring now to FIG. 4, an exemplary system for accessing information for available persons is illustrated. In some examples, an available person may wear a watch 410 with a logo 400 that may further comprise a tag, which may be wirelessly detectable by a mobile device 450, such as a smartphone, tablet, or laptop. In some examples, the tag may comprise an energized or energizable component, wherein the tag may be capable of wirelessly transmitting 405 identification information to the mobile device 450.

In some examples, the tag may comprise an energy source, such as a battery. In such examples, the energy source may be rechargeable, such as through solar power or energy harvesting. In other examples, the tag may be capable of accepting power, wirelessly or through a wired connection. For example, where a logo may be affixed to a building, the tag may be plugged into an outlet, similarly to a neon sign in a storefront window. Alternatively, a tag may comprise an antenna that may accept power from predefined reader devices. A mobile device 450 may be equipped with the transmitting technology, such as Bluetooth, or additional hardware may be necessary. For example, a dongle may be attached, which may transmit energy and/or receive the wireless transmission 405 of data.

In some examples, the mobile device 450 may receive the wireless transmission 405, and notify the prospective party that a tag has been detected. For example, the notification may comprise an audible, tactile, and/or visual alert. In some examples, the notification may prompt the prospective party to acknowledge the alert, or the notification may further include a snapshot of the data associated with the logo 400. For example, the mobile device 450 may present a photo 455 and profile information 460 of the available person. The prospective party may review the details and determine if they may want to show interest. The Interested Party may click on an icon 465, which may, in some examples, initiate direct communication with the available person associated with the logo 400. For example, the direct communication may be a text, which may enable the available person to directly respond, without exchanging personal contact information.

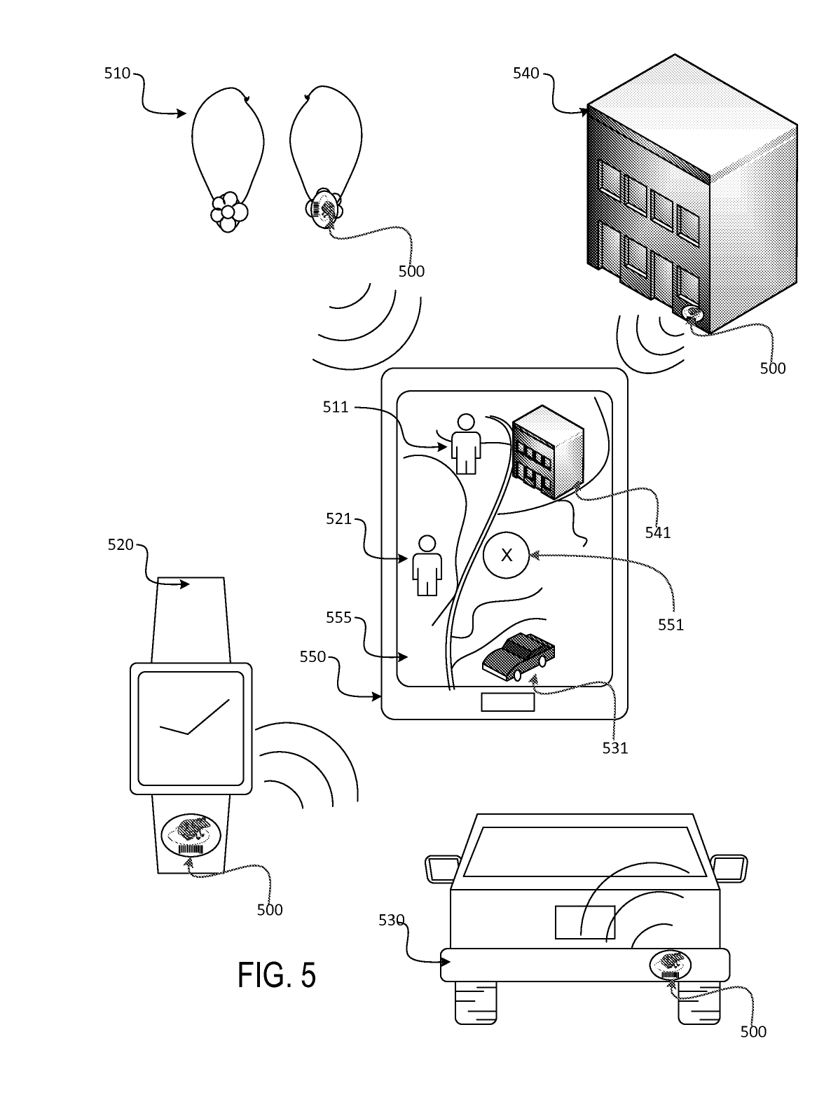

Referring now to FIG. 5, an exemplary system for accessing product information of multiple available products is illustrated.

A mobile device 550 may be able to detect a variety of product types or persons, or in other examples, the mobile device 550 may only detect a specific product type or person.

In some examples, the mobile device 550 may present detected products and persons to the prospective party simultaneously, such as through a map view 555. For example, the map view 555 may present a road map of the vicinity and indicate the prospective party position 551 on the map. Each detected available product, service or person may be indicated by category icons within the map. Such a presentation may allow for dynamic interfacing, which may be practical when one or more of the prospective party or available products or persons may be mobile.

As an illustrative example, a mobile device 550 may detect a woman wearing earrings 510 with a logo 500, a man wearing a watch 520 with a logo 500, a vehicle 530 with a logo 500 on its bumper, and a building 540 with a logo 500. The map view 555 may show two people icons 521, 511 for the man's watch 520 and the woman's earrings 510, respectively; a car icon 531 for the vehicle 530; and a building icon 541 for the building 540.

In some examples, a prospective party may set desired products and/or product attributes, which may allow their mobile computing device to passively detect and filter available products with tags. As an illustrative example, a prospective party may be searching for an SUV and an apartment, and his mobile device may detect six nearby tags: a building for sale; an apartment building with available apartments; a motorcycle for sale; a limousine for rent; an SUV for sale; and a person from a dating website. The device may filter the results and notify the prospective party only of the SUV and the apartment building listings.

The prospective party may investigate any of the available products or persons by physically going to their location or may select the appropriate icon to access their information. Where the prospective party becomes an Interested Party, the communication may be similar to that described in FIG. 3.

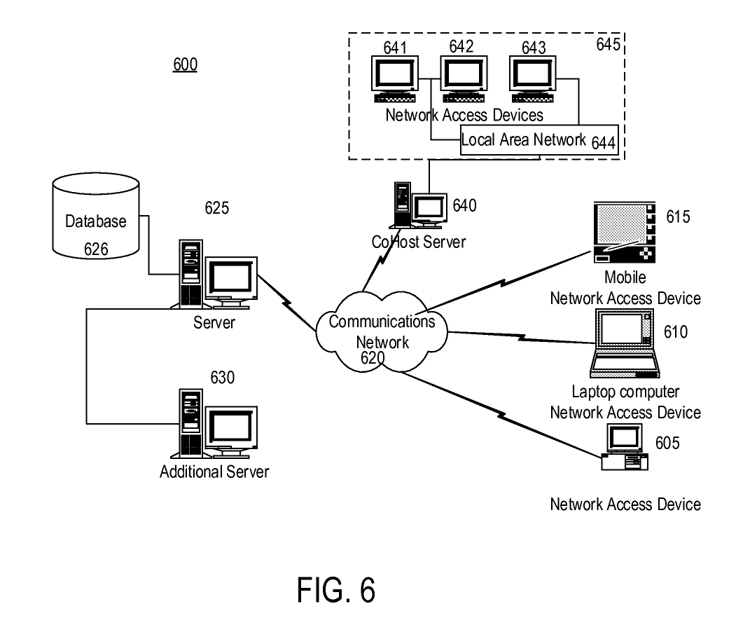

Referring now to FIG. 6, an exemplary processing and interface system 600 is illustrated. In some aspects, access devices 615, 610, 605, such as a mobile device 615 or laptop computer 610 may be able to communicate with an external server 625 though a communications network 620. The external server 625 may be in logical communication with a database 626, which may comprise data related to identification information and associated profile information.

In some examples, the server 625 may be in logical communication with an additional server 630, which may comprise supplemental processing capabilities.

In some aspects, the server 625 and access devices 605, 610, 615 may be able to communicate with a cohost server 640 through a communications network 620. The cohost server 640 may be in logical communication with an internal network 645 comprising network access devices 641, 642, 643 and a local area network 644. For example, the cohost server 640 may comprise a payment service, such as PayPal or a social network, such as Facebook or a dating website.

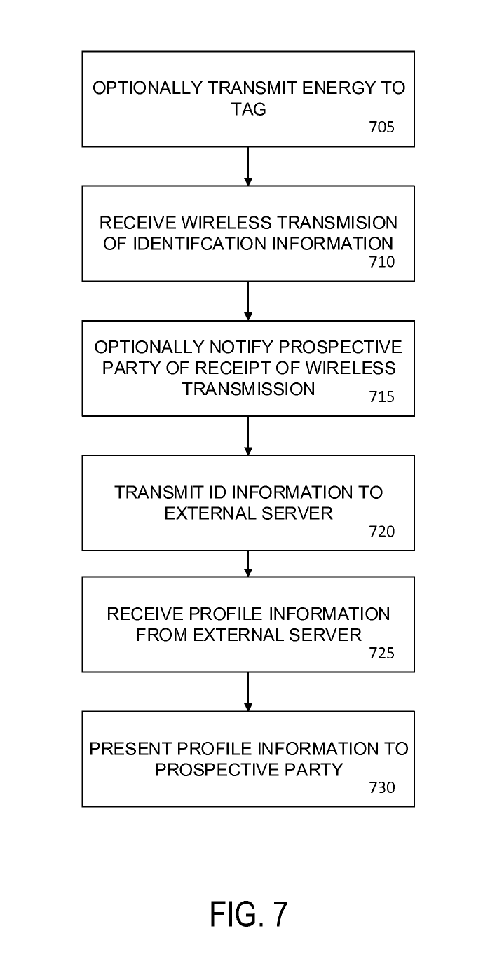

Referring now to FIG. 7, exemplary method steps for wirelessly receiving profile information, wherein the identification information may be received through a wireless transmission from a tag on a logo, are illustrated. In some examples, at 705, energy may be transmitted to a tag on a logo. At 710, identification information may be wirelessly received, such as illustrated in FIGS. 4 and 5. In some examples, at 715, a prospective party may be notified of receipt of the wireless transmission.

At 720, the identification information may be transmitted to an external server, such as described in FIG. 6, for example. At 725, profile information may be received from the external server. At 730, the profile information may be presented to the prospective party.

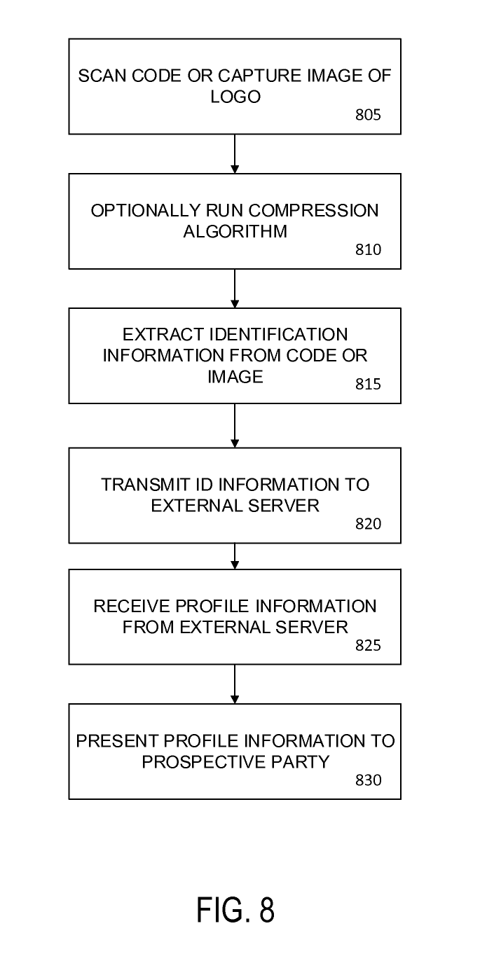

Referring now to FIG. 8, exemplary method steps for wirelessly receiving profile information, wherein the identification information may be retrieved through capture of a code or image of a logo, are illustrated. At 805, a code on a logo may be scanned, or an image of the logo may be captured, such as shown in FIG. 3. In some examples, where the identification information may be embedded in the code or image, at 810, a compression algorithm may be run on the code or image. At 815, identification information may be extracted from the code or image.

At 820, the identification information may be transmitted to an external server, such as described in FIG. 6. At 825, profile information may be received from the external server. At 830, the profile information may be presented to the prospective party.

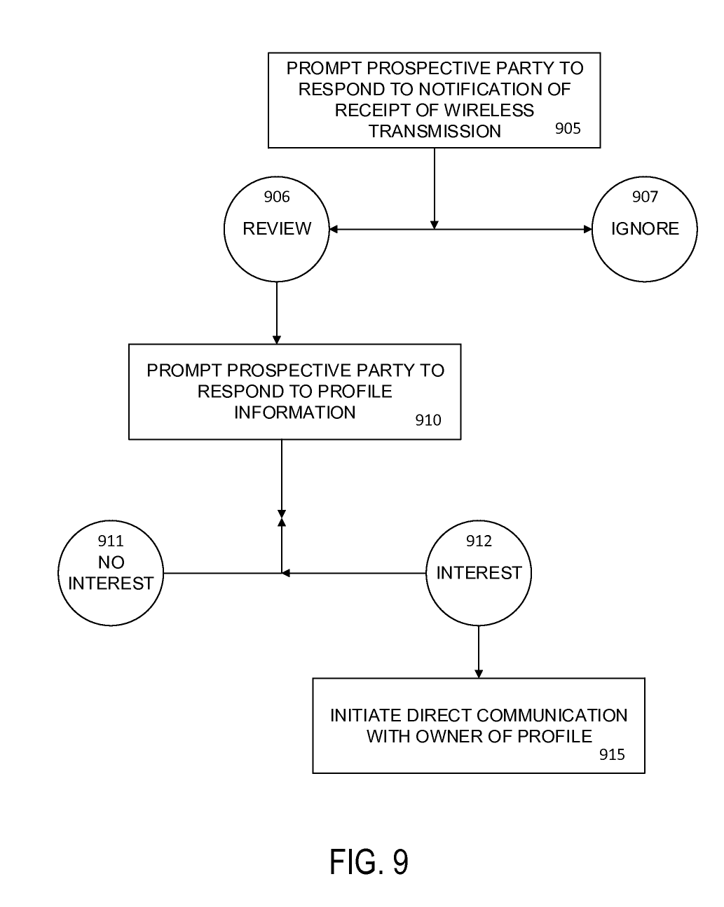

Referring now to FIG. 9, exemplary method steps for initiating direct communication between a profile owner and an Interested Party are illustrated. In some aspects, at 905, a prospective party may be prompted to respond to a notification of receipt of a wireless transmission of identification information. Where the prospective party may decide to ignore 907 the identification information, the process may terminate. Where the prospective party may decide to review the profile 906, the prospective party may be prompted to respond to the profile information at 910.

Where the prospective party may decide they are not interested 911 in the available product, service or person, the process may terminate. Where the prospective party may want to show interest 912, they may become an Interested Party, and, at 915, direct communication with the owner of the profile may be initiated.

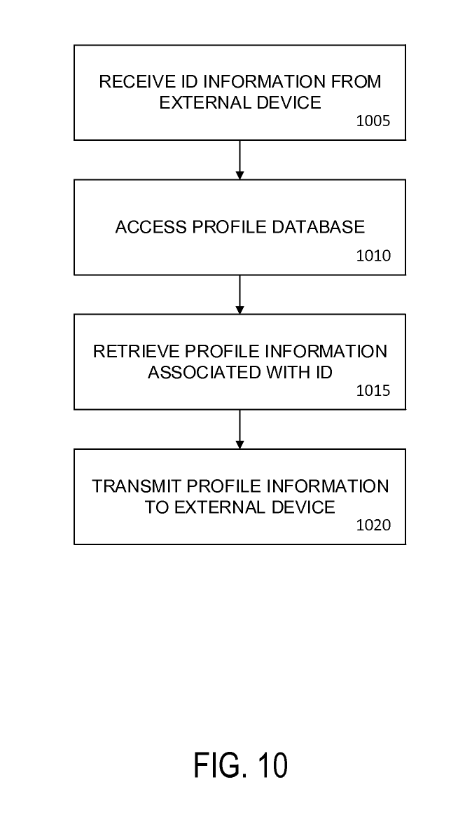

Referring now to FIG. 10, exemplary method steps for transmitting profile information to an external device are illustrated. At 1005, identification information may be received from an external device. At 1010, a profile database, such as illustrated in FIG. 6, may be accessed. At 1015, profile information associated with the identification information may be retrieved from the profile database. At 1020, the profile information may be transmitted to the external device.

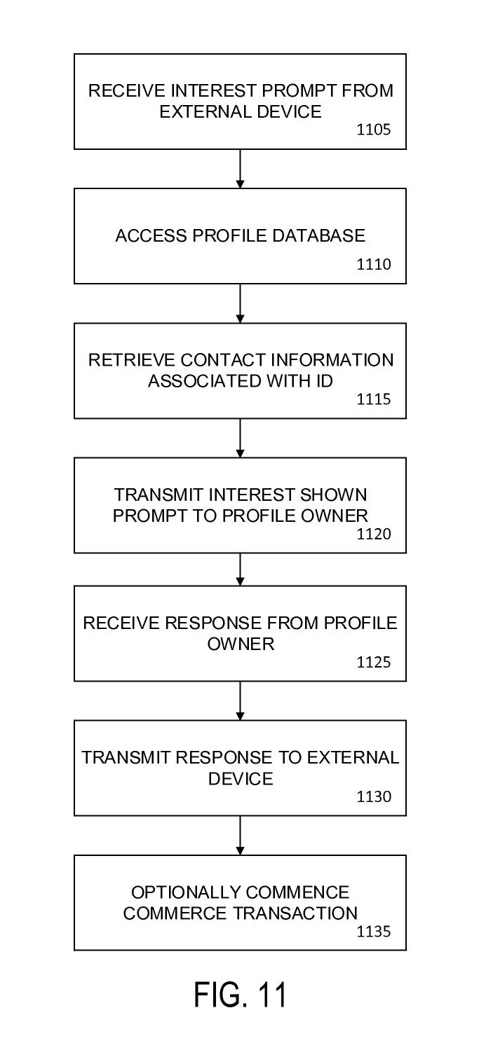

Referring now to FIG. 11, exemplary method steps for allowing direct communication between a profile owner and an Interested Party are illustrated. At 1105, an interest prompt may be received from an external device. At 1110, a profile database, such as illustrated in FIG. 6, may be accessed. At 1115, contact information associated with the identification information may be retrieved.

At 1120, an interest shown prompt may be transmitted to the profile owner. The transmittal means may depend on the contact information and contact preferences provided by the profile owner. For example, in some aspects, the profile owner may prefer receiving communication from interested parties through text, whereas others may prefer communicating through a social network, such as Twitter, Facebook, or a dating website.

At 1125, a response from the profile owner may be received, and at 1130, the response may be transmitted to the external device. In some examples, the steps at 1105, 1120, 1125, and 1130 may be repeated throughout the communication between an Interested Party and a profile owner. In some examples, where the Interested Party and the profile owner may come to an agreement of terms, at 1135, a commerce transaction may be commenced.

A number of examples of the present disclosure have been described. While this specification contains many specific implementation details, there should not be construed as limitations on the scope of any disclosures or of what may be claimed, but rather as descriptions of features specific to particular examples of the present disclosure.

Certain features that are described in this specification in the context of separate examples can also be implemented in combination in a single embodiment. Conversely, various features that are described in the context of a single embodiment can also be implemented in combination in multiple examples separately or in any suitable sub-combination. Moreover, although features may be described above as acting in certain combinations and even initially claimed as such, one or more features from a claimed combination may, in some cases, be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the examples described above should not be understood as requiring such separation in all examples, and it should be understood that the described program components and systems can generally be integrated together in a single software product or packaged into multiple software products.

While the disclosure has been described in conjunction with specific examples, it is evident that many alternatives, modifications, and variations will be apparent to those skilled in the art in light of the foregoing description. Accordingly, this description is intended to embrace all such alternatives, modifications, and variations as fall within its spirit and scope.

Although shown and described in what is believed to be the most practical and preferred examples, it may be apparent that departures from specific designs and methods described and shown will suggest themselves to those skilled in the art and may be used without departing from the spirit and scope of the disclosure. The present disclosure is not restricted to the particular constructions described and illustrated, but should be constructed to cohere with all modifications that may fall within the scope of the appended claims

What is claimed is:

1. A computing apparatus capable of facilitating communication between an advertiser and an Interested Party, wherein the computing apparatus comprises:
a communications network access device for accessing a server in logical communication with a communications network; and
executable software stored on the communications network access device and executable on demand, the software operative with the communications network access device to cause the network access device to:
receive identification information associated with an available product, service or person, wherein an owner is associated with the available product, service or person;
transmit the identification information to an external server;
receive profile information from the external server, wherein the profile information is associated with the transmitted identification information;
present the profile information to a prospective party;
prompt the prospective party to respond to the presented profile information; and
receive response from the prospective party, wherein the response is indicative of interest or lack of interest in the available product, service or person.

2. The computing apparatus of claim 1, wherein the identification information is logically embedded in a logo configured to be placed on or proximate to the available product, service or person.

3. The computing apparatus of claim 2, wherein the logo further comprises a tag configured to wirelessly transmit the identification information to the network access device.

4. The computing apparatus of claim 3, wherein the communications network access device is further caused to transmit energy to the tag.

5. The computing apparatus of claim 1, wherein the communications network access device is further caused to notify the prospective party of a receipt of the identification information.

6. The computing apparatus of claim 2, wherein the identification information is logically embedded in a readable code portion of the logo.

7. The computing apparatus of claim 1, wherein the response indicates interest in the available product, service or person, and wherein a prospective party becomes an Interested Party, and wherein the communications network access device is further caused to initiate communication between the Interested Party and the owner.

8. The computing apparatus of claim 7, wherein the communication between the Interested Party and the owner further causes the communications network access device to:
transmit the response to the owner;
receive a first communication from the owner;
present the first communication to the Interested Party;
receive a second communication from the Interested Party; and
transmit the second communication to the owner.

9. The computing apparatus of claim 8, wherein the first or the second communication comprises a transaction offer for the available product, service or person between the owner and the Interested Party.

10. The computing apparatus of claim 9, wherein the first or the second communication comprises an acceptance of the transaction offer for the available product, service or person.

11. The computing apparatus of claim 10, wherein the communications network access device is further caused to commence a commercial transaction based on the transaction offer.

12. A method of initiating communication between at least two parties, the method comprising the steps of :
providing an identification device to a first user, wherein the identification device contains a unique identifier;
providing application software to a second user, wherein the application software may be operated on a first computing device, wherein the first computing device may also interact with the identification device to extract the unique identifier;
receiving on a second computing device a communication originating from the first computing device, wherein the communication signals an interest prompt from the application software operating on the first computing device;
extracting the unique identifier from the communication;
accessing a database, wherein the database contains profile information, wherein at least a portion of the profile information may be associated with the unique identifier;
retrieving a contact information data segment associated with the unique identifier from the database; and
transmitting a data stream to a third computing device, wherein the data stream contains the interest prompt and the contact information data segment, wherein the third computing device is associated with the first user.

13. The method of claim 12 additionally comprising the steps of:
presenting the data stream to an operator of the third computing device, wherein the presenting of the data stream identifies to the operator of the third computing device the interest prompt and the contact information data segment; and
collecting a user response from the operator of the third computing device;
transmitting a data stream to the first computing device, wherein the application software operating on the first computing device may process the data stream; and
communicating to an operator of the first computing device a response, wherein the response is based upon the information in the data stream.

14. The method of claim 12 wherein the identification device comprises an image.

15. The method of claim 14 wherein the image comprises a logo associated with a first entity, wherein the first entity provided the application software operating on the first computing device.

16. The method of claim 14 wherein the image comprises a modified logo associated with a second entity, wherein the second entity is associated with the first user.

17. The method of claim 14 wherein the identification device comprises a wireless communication device.

18. The method of claim 17 wherein the wireless communication device comprises an RFID.

19. The method of claim 18 wherein the wireless communication device comprises a Bluetooth enabled device.

20. The method of claim 12 wherein:
the first computing device is a smartphone;
the interaction with the identification device includes collecting a camera image with smartphone; and
the extracting of the unique identifier is performed by processing which includes recognizing bar code identification within the camera image.
